(19) United States
(12) Patent Application Publication
(10) Pub. No.: US 2006/0029158 A1
(43) Pub. Date: Feb. 9, 2006

(54) Amplitude peak cancellation

(76) Inventors: Dietmar Lipka, Berg (DE); Jurgen Dietz, Tuntenhausen (DE); Georg Frank, Nurnberg (DE)

Correspondence Address: NIXON & VANDERHYE, PC, 901 NORTH GLEBE ROAD, 11TH FLOOR, ARLINGTON, VA, 22203, US

(21) Appl. No.: 10/535,451

(22) PCT Filed: Nov. 29, 2002
(86) PCT No.: PCT/EP02/13528

§ 371 Date: Jul. 19, 2005

(51) Int. Cl. H04L 27/04

(52) U.S. Cl. 375/300

(57) ABSTRACT

A method of preventing amplitude peaks from appearing in a processed signal that has been generated from at least one baseband signal by one or more signal processing operations is described. The method includes two or more individual peak cancellation steps, each peak cancellation step including deriving an estimate for the processed signal, assessing the estimate to detect amplitude peaks, and adjusting the baseband signal to prevent any detected amplitude peaks from appearing in the processed signal later on. The invention also relates to a peak cancellation stage for efficiently performing peak cancellation.

### FIELD OF THE INVENTION

The present invention relates to a method and a device for cancelling amplitude peaks. More specifically, the invention relates to preventing amplitude peaks from appearing in a signal that has been generated from one or more baseband signals.

### BACKGROUND OF THE INVENTION

Efficient multiple access techniques are an important pre-requisite to guarantee the high traffic handling capacities of modern telecommunications systems. Multiple access techniques permit a plurality of users to simultaneously access a specific resource by dividing a common communications medium into individual channels.

There are three basic types of multiple access techniques, namely frequency division multiple access (FDMA), time division multiple access (TDMA) and code division multiple access (CDMA). Unlike FDMA and TDMA, CDMA allows a plurality of different traffic channel signals to be simultaneously transmitted in such a way that they overlap in both the time domain and the frequency domain. In order to distinguish each traffic channel signal from the other traffic channel signals, each traffic channel signal is encoded with one or more unique spreading codes, as is well-known in the art. The individual traffic channel signals are eventually combined into a single, multicode CDMA signal, which is up converted and amplified prior to transmission.

Combining multiple traffic channel signals into a single CDMA signal or independent CDMA signals into a combined CDMA signal is advantageous in that only a single power amplifier is required rather than a separate power amplifier for each traffic channel signal or each independent CDMA signal. However, the combination of individual traffic channel signals or independent CDMA signals leads to a significantly increased peak-to-average power ratio associated with the resulting power amplifier input signal. The drawback associated with a large peak-to-average power ratio is that it limits the power amplifier efficiency.

In order to effectively reduce the peak-to-average power ratio in such a way that the power amplifier efficiency is not degraded it is proposed in U.S. Pat. No. 6,266,320 B1 to digitally limit the amplitude associated with each independent CDMA carrier. This is accomplished by means of an amplitude limitation device arranged in a baseband signal path before a block of pulse shaping filters. The amplitude limitation device measures the instantaneous amplitude for the individual signal components that make up each CDMA carrier, derives a maximum amplitude based on the instantaneous amplitude measurements, and determines scaling factors based on the maximum amplitude. The scaling factors are then applied to the individual signal components, which are subsequently pulse shape filtered, combined and modulated by a corresponding CDMA carrier frequency.

As the instantaneous amplitudes are limited before the signals are applied to the pulse shaping filters, the spectral widths of the signal components at the output of each pulse shaping filter remain within the limits defined by the characteristics of the pulse shaping filter. Otherwise, i.e. if peak limitation was performed after spectral shaping, the amplitude limitation process would result in a distortion of the signal shape.

Despite the advantages of performing amplitude limitation prior to pulse shaping, peak amplitude increases resulting from overshoots caused by the pulse shaping filters have been observed for example in Wideband CDMA systems, which employ a root raised cosine (RRC) filter for pulse shaping. Such overshoot events can cause a typical maximum additional peak-to-average amplitude ratio up to 4.5 dB higher than the peak-to-average ratio after amplitude limitation. Prevention of such overshoot events does not only increase the potential to reduce the back off for the power amplifier, yielding a much better power amplifier efficiency, but also allows to reduce the back off for the digital signal processing components and the digital-to-analog converter, yielding a higher dynamic range for the transmitter.

A possible solution, which ensures that signal overshoots introduced by signal processing components like filters inserted in the signal path subsequent to an amplitude limitation stage are reduced, is proposed in WO 02/11283 A2. The solution basically consists in the provision of an estimation filter for determining the actual signal overshoot over a predefined threshold value that is introduced by signal processing components that are arranged in the signal path after the amplitude limitation stage. Taking into account the estimated signal overshoot the signal amplitude can be adjusted prior to the signal processing components which cause the overshoots. Hence, the appearance of signal overshoots after the signal processing components is prevented. Since any signal adjustment could produce new amplitude peaks, a recursive approach is implemented which after each signal adjustment assesses the adjusted signal in a backward direction to look for newly introduced amplitude peaks that will then be removed. This recursive approach including a backwardly directed search is time consuming and difficult to implement.

There is a need for a method and device for efficiently preventing amplitude peaks from appearing in a processed signal that has been generated from at least one baseband signal by one or more signal processing operations like pulse shaping, carrier combination, etc..

### SUMMARY OF THE INVENTION

As regards a method, this need is satisfied according to the invention by successively performing two or more peak cancellation steps. A first peak cancellation step includes deriving from the baseband signal a first estimate for the processed signal, assessing the first estimate to detect amplitude peaks, and adjusting the baseband signal which is to be processed to prevent any amplitude peaks detected in the first estimate from appearing in the processed signal. The baseband signal to be processed which has been subjected to the first peak cancellation step is then subjected to at least one additional peak cancellation step. The at least one additional peak cancellation step includes deriving from the adjusted baseband signal a second estimate for the processed signal, assessing the second estimate to detect amplitude peaks, and further adjusting the already adjusted baseband signal to prevent any amplitude peaks detected in the second estimate from appearing in the processed signal.

This successive cancellation technique including two or more individual peak cancellation steps modifies a baseband signal which is to be (further) processed prior to the actual (further) processing thereof and advantageously aimes at cancelling amplitude peaks that would otherwise, i.e. if no peak cancellation was performed, be observable in the processed baseband signal. The amplitude peaks to be cancelled may for example already be included in the baseband signal to be processed or may be introduced in the course of one or more signal processing operations performed during or after at least the first peak cancellation step. Signal processing operations that can be taken into account during peak cancellation may be performed in the digital or in the analog domain and may relate to e.g. signal shaping, signal combining, signal scaling, signal converting, etc..

The two or more peak cancellation steps performed according to the invention may be identical or different. For example, in different peak cancellation steps different signal processing operations may be considered when deriving an estimate for the processed signal. Also, different amplitude peak detection mechanisms or baseband signal adjusting mechanisms may be used.

One or more peak cancellation steps or each peak cancellation step may be performed such that in the course of a particular peak cancellation step any additional peaks introduced by this peak cancellation step are not considered further during this peak cancellation step. Any amplitude peaks still present after a preceding peak cancellation step in the baseband signal to be processed may then be cancelled during a subsequent peak cancellation step. Thus, a particular peak cancellation step may be performed in the forward direction only, i.e. non-backwardly, and/or non-recursively. Thus, the processing delay associated with an individual peak cancellation step can advantageously be reduced compared with for example a recursive approach.

In two or more of the successive peak cancellation steps an estimate for the processed signal is derived from the baseband signal to be processed. The respective estimates may be derived in various ways, preferably by simulating the effects of a predefined signal processing scheme applied to obtain the processed signal. If, for example, the processed signal is obtained from the baseband signal to be processed by a succession of various processing operations, the estimate may be derived by simulating the effects of these processing operations with respect to the baseband signal. According to a first variant, the simulation is exact, i.e. the estimate for the processed signal is identical with the processed signal. This will usually imply that the signal processing operations have to be performed twice, namely a first time to derive the estimate and a second time to obtain the processed signal to be transmitted. According to a second variant, the simulation is not exact, i.e. the estimate for the processed signal only approximately corresponds to the processed signal.

Depending on the number of signal processing operations to be simulated, the step of deriving an estimate for the processed signal may include one or more substeps like one or more of a signal shaping (e.g. filtering) substep, a signal combination substep, a signal scaling substep, etc.. If deriving an estimate for the processed signal includes filtering, interpolation filtering (e.g. polyphase filtering) may be used.

Once an estimate for the processed signal has been derived, the estimate has to be accessed with respect to the presence of amplitude peaks. To that end, various amplitude peak detection schemes could be implemented. A preferred amplitude peak detection scheme is based on a threshold decision. This means that an amplitude peak to be prevented from appearing in the processed signal may be identified in the estimate by searching the estimate for signal portions that lie above a fixed or moving threshold. Individually defined thresholds may be used in the various peak cancellation steps.

The assessment of an estimate for the processed signal with respect to the presence of amplitude peaks may be based on a routine that produces a specific output signal each time a peak maximum which is higher than a preferably predefined threshold is detected. For example, such a routine may produce a train of output signals at the specific time positions of peak maxima for further evaluation.

Once a peak to be cancelled in the processed signal has been detected in the estimate for the processed signal, the baseband signal to be processed may be adjusted such that the detected amplitude peak will not appear in the processed signal. This adjustment preferably includes generating an appropriate correction signal which is to be associated with the baseband signal to be adjusted. Such an association may for example include a summation or multiplication operation. For example, an amplitude peak detected in the estimate may be removed by adding to the baseband signal to be processed a correction signal in the form of a negative pulse. The correction signal in pulse form is preferably chosen such that it does not widen the signal spectrum and has minimum energy.

Numerous possibilities for determining the correction signal can be used. For example, the correction signal may be derived by way of filtering, preferably flat spectrum filtering. To that end the previously mentioned train of output signals at the time positions of peak maxima may be subjected to a filtering operation to obtain a correction signal of an appropriate shape.

During a particular peak cancellation step, the filtering applied when deriving the estimate for the processed signal may differ from the filtering which is applied when deriving the correction signal. For example the estimate for the processed signal may be derived on the basis of a filtering characteristics which is more complex than the filtering characteristics of the filtering applied when deriving the correction signal.

Before, after and/or between the individual peak cancellation steps the baseband signal to be processed may be subjected to various additional steps like one or more clipping steps or a signal power loss compensation step. Preferably, a power loss compensation step is performed at least after the last peak cancellation step to compensate the average signal power reduction that resulted from the amplitude peak removal.

According to a multi carrier scenario of the invention, a plurality of baseband signals in the form of individual carriers are individually and in parallel subjected to one or more of the peak cancellation steps. In such a case a combined estimate may be derived for the plurality of carriers and the assessment performed in context with amplitude peak detection can be based on the combined estimate.

The invention can be implemented as a hardware solution or as a computer program product comprising program code portions for performing the steps discussed above when the computer program product is run on a computing device. The computer program product may be stored on a data carrier in fixed association with or removable from the computing device.

As regards the hardware solution, the invention is directed to a peak cancellation stage which comprises at least two separate peak cancellation units. A first peak cancellation unit of the peak cancellation stage includes an estimating element for deriving from a baseband signal to be processed a first estimate for the processed signal, a detector for assessing the first estimate to detect amplitude peaks, and an adjusting element for adjusting the baseband signal to prevent any amplitude peaks detected in the first estimate from appearing in the processed signal. At least one additional peak cancellation unit is arranged in a signal path behind the first peak cancellation unit and includes an estimating element for deriving from the adjusted baseband signal a second estimate for the processed signal, a detector for assessing the second estimate to detect amplitude peaks, and an adjusting element for further adjusting the already adjusted baseband signal to prevent any amplitude peaks detected in the second estimate from appearing in the processed signal. The estimating element of each peak cancellation unit may include one or more individual estimating components, each estimating component performing an individual estimating step and e.g. simulating an individual processing operation of the one or more signal processing operations that will later be applied to the baseband signal.

According to a preferred variant of the invention, one or more of the peak cancellation units have two or more individual signal branches which are arranged in parallel. A particular peak cancellation unit may for example have a first signal branch including at least the estimating element and the detector and a second signal branch including a delay element. The delay element is preferably configured such that it compensates the latency associated with at least the estimating element and the detector such that the baseband signal to be adjusted is received by the adjusting element more or less synchronously with generation of a compensation signal.

The peak cancellation stage may additionally comprise one or more clipping units for limiting the amplitude of the baseband signal. With respect to a particular peak cancellation unit a clipping unit is advantageously arranged in a common signal path before the individual signal branches of this peak cancellation unit.

In addition or as an alternative to the provision of one or more clipping units, one or more power loss compensators may be included in the peak cancellation stage. A particular power loss compensator is preferably arranged behind one, more or all of the peak cancellation units and is configured such that at least the power loss resulting from one, more or all of the peak cancellation units is compensated. Additionally, the power loss compensator may take the power loss that is associated with one or more of the clipping units into account. According to an advantageous variant of the invention, the power loss compensator includes a signal loop that taps the signal path before the first peak cancellation unit.

The peak cancellation stage may be part of a transmitting device like a mobile terminal or a base station.

### BRIEF DESCRIPTION OF THE DRAWINGS

In the following the invention will be described with reference to exemplary embodiments illustrated in the figures, in which:

FIG. 1 is a block diagram of a single carrier transmit chain according to a first embodiment of the present invention;

FIG. 2 is a block diagram of a multi carrier transmit chain according to a second embodiment of the present invention;

FIG. 3 is a block diagram of an exemplary peak cancellation stage according to the invention including a baseband clipping unit, several peak cancellation units and a power loss compensator;

FIG. 4 is a block diagram of the baseband clipping unit of FIG. 3;

FIG. 5 is a block diagram of one of the peak cancellation units of FIG. 3;

FIG. 6 is a block diagram of a first estimating component in the form of a filter block;

FIG. 7 is a diagram depicting the filter characteristics of one of the filters depicted in FIG. 6;

FIGS. 8a and 8b are block diagrams depicting two different configurations of a second estimating component of the peak cancellation stage depicted in FIG. 5;

FIGS. 9a and 9b are block diagrams of two different embodiments of a detector of the peak cancellation unit depicted in FIG. 5;

FIG. 10 is a block diagram of an adjusting component in the form of a block of peak cancellation filters;

FIG. 11 is a diagram depicting the filter characteristics of one of the peak cancellation filters of FIG. 10; and

FIG. 12 is a block diagram of the power loss compensator of FIG. 3;

FIG. 13 shows a comparison of the results of different peak cancellation techniques.

### DETAILED DESCRIPTION OF PREFERRED EMBODIMENTS

In the following description, for purposes of explanation and not limitation, specific details are set forth, such as particular embodiments, circuits, signal formats etc. in order to provide a thorough understanding of the present invention. It will be apparent to one skilled in the art that the present invention may be practiced in other embodiments that depart from these specific details. In particular, while the different embodiments are described herein below incorporated with a Wideband CDMA transmission device, the present invention is not limited to such an implementation, but for example can be utilized in any transmission device in which peak power reduction is required. Moreover, those skilled in the art will appreciate that the functions explained herein below may be implemented using individual hardware circuitry, using software functioning in conjunction with a programmed microprocessor or general purpose computer, using an application specific integrated circuit (ASIC), and/or using one or more digital signal processors (DSPs).

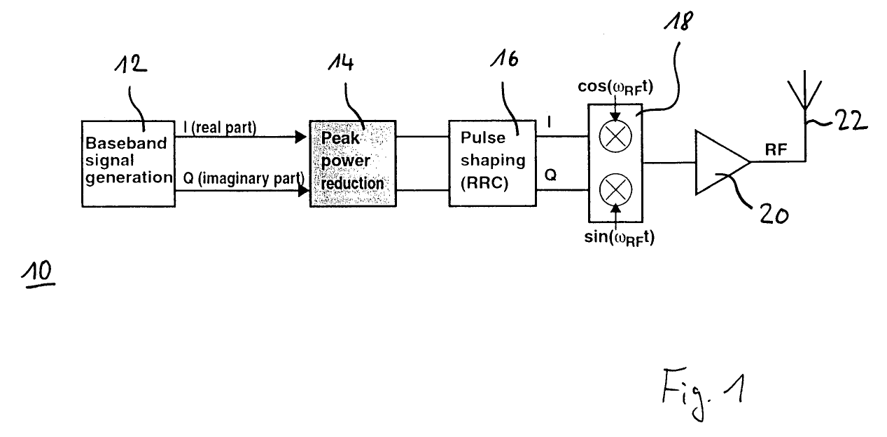

Referring to FIG. 1, a single carrier transmit chain 10 of a transmitting device according to the present invention is shown. As can be seen from FIG. 1, the transmit chain 10 includes a component 12 for generating a baseband signal, a peak cancellation stage 14, a component 16 for pulse shaping, a modulator 18, a power amplifier 20 and an antenna 22.

From user data input into the component 12 a complex baseband signal including an in-phase part I and a quadrature part Q is generated. In the case of the exemplary Wideband CDMA system, generation of the baseband signal includes encoding, interleaving, baseband modulation, channel spreading using a binary channel code sequence, channel weighting, channel combination, and multiplication with a complex scramble code.

The baseband signal generated by the component 12 is input to the peak cancellation stage 14 which adjusts the baseband signal as will be explained in more detail below. The adjusted baseband signal output by the peak cancellation stage 14 is then subjected to a further signal processing operation in the component 16 for pulse shaping. The component 16 is configured as a pulse shaping filter which defines the spectral characteristics of the signal transmitted by the antenna 22. According to the specifications of Wideband CDMA, the pulse shaping filter 16 is a root raised cosine filter with roll off factor of 0.22. The pulse shaped baseband signal output by the pulse shaping filter 16 is IQ modulated by the modulator 18, up converted to radio frequency (not shown in FIG. 1), amplified by the power amplifier 20 and transmitted via the antenna 22.

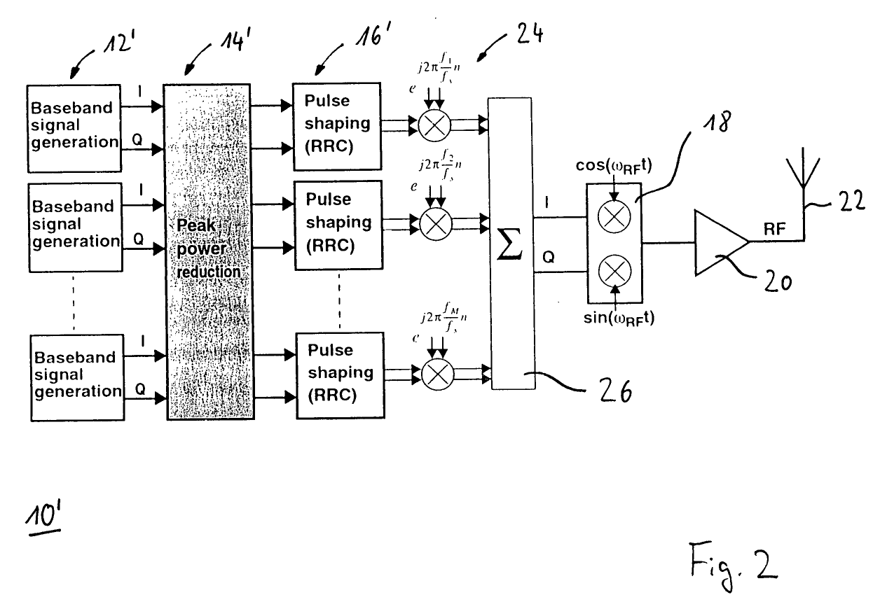

The single carrier transmit approach depicted in FIG. 1 can be extended to a transmitting device with a multi carrier transmit chain 10′ as depicted in FIG. 2. The multi carrier transmit chain 10′ comprises a baseband signal generation block 12′, a multi carrier peak cancellation stage 14′, a pulse shaping block 16′, a digital combiner including a multiplier block 24 and an adder 26, a modulator 18, a power amplifier 20 and an antenna 22.

Since the basic operation principals of the multi carrier transmit chain 10′ are identical with those described above in context with the single carrier transmit chain of FIG. 1, only aspects relating to the multi carrier approach will be described in more detail. According to the multi carrier approach, a plurality of baseband signals is generated individually and individually subjected to peak cancellation and pulse shaping. The individual baseband signals output by the pulse shaping block 16′ are then input to the multiplier block 24 which multiplies each of the individual baseband signals with a complex oscillator signal that shifts the center frequencies of the baseband signals relative to each other. The frequency shifted baseband signals are input into the adder 26 which generates a joint baseband signal. The joint baseband signal is then IQ modulated, up converted, power amplified and transmitted via the antenna 22.

As can be seen from FIGS. 1 and 2, the peak cancellation stages 14, 14′ are located before subsequent signal processing components like the pulse shaping filter 16 of FIG. 1 or the pulse shaping block 16′ and the carrier combination components 24, 26 of FIG. 2. In other words, peak cancellation is performed prior to pulse shaping and carrier combination.

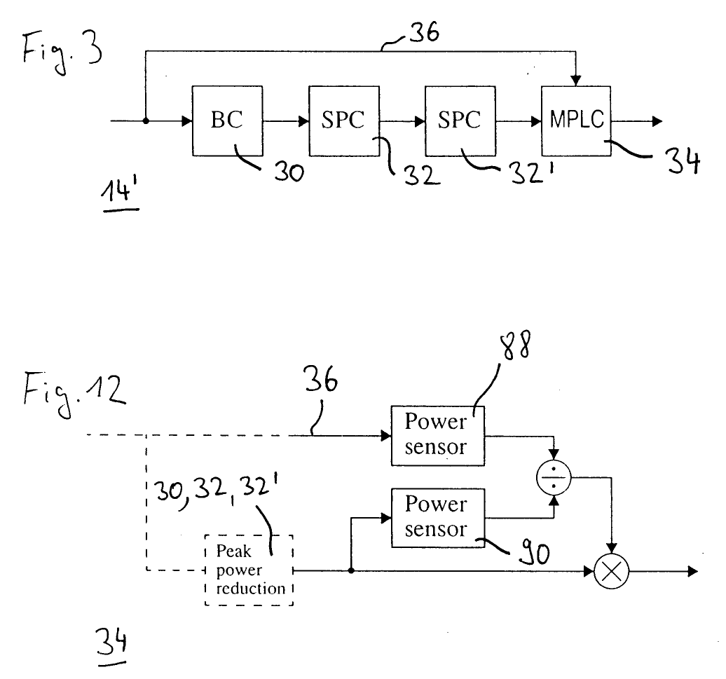

An exemplary construction of the peak cancellation stage 14′ of FIG. 2 will now be explained in more detail with reference to FIG. 3. As can be gathered from FIG. 3, the peak cancellation stage 14′ includes a baseband clipping unit 30, a first peak cancellation unit 32 following the baseband clipping unit 30, a second peak cancellation unit 32′ arranged in a signal path behind the first peak cancellation unit 32′, and a mean power loss compensator 34 situated behind the second peak cancellation unit 32′.

The baseband clipping unit 30 performs amplitude clipping such that the signal amplitudes of the signal output by the baseband clipping unit 30 never exceed a predefined threshold. The clipped baseband signal is input to the first peak cancellation unit 32 which performs a first peak cancellation step as will be described in more detail below. During the first peak cancellation step secondary, but usually lower peaks may be introduced on both sides of a cancelled peak or the peak to be cancelled may not be removed completely. The presence of secondary peaks or peaks that have not completely been removed in the adjusted baseband signal output by the first peak cancellation unit 32 are an expression of the fact that the first peak cancellation unit 32 performs peak cancellation in forward direction only.

The adjusted baseband signal including secondary peaks or peaks that have not completely been removed is input to the second peak cancellation unit 32′ which performs a similar peak cancellation strategy like the first peak cancellation unit 32. The second peak cancellation unit 32′ may also leave remaining peaks that could be removed by a third peak cancellation stage (not depicted) and so on. It is apparent that with each peak cancellation unit the number and magnitude of remaining peaks in the successively adjusted baseband signal becomes lower and lower. In the exemplary embodiment depicted in FIG. 3, a peak cancellation stage having two peak cancellation units 32, 32′ is shown. Depending on the actual needs, further peak cancellation units could be added.

As a consequence of the peak cancellation performed by the peak cancellation units 32, 32′ the average signal power is reduced by up to 1 dB. This mean power loss is compensated by the mean power loss compensator 34 located in the signal path after the last peak cancellation unit 32′. The power loss compensator 34 measures the average signal power before the baseband clipping unit 30 (using a loop 36) and after peak cancellation. Based on the difference between the measurements a compensation gain is calculated and the average power of the adjusted baseband signal output by the second cancellation unit 32′ is raised accordingly.

In the following, the structure and operation of the individual components of the transmit chain 14′ depicted in FIG. 3 will be explained in the detail.

### Baseband Clipping

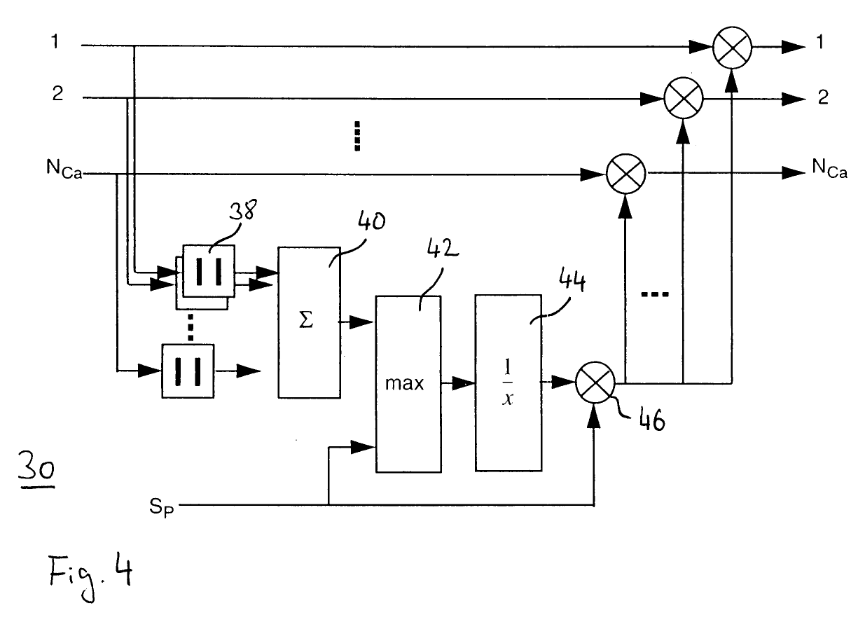

The structure and operation of the clipping unit 30 shown in FIG. 3 will now be described with reference to FIG. 4. In FIG. 4 a block diagram of the baseband clipping unit 30 for multiple carriers 1, 2 . . . N_{Ca} is depicted. In the baseband clipping unit 30 of FIG. 4 a chip sequence of a multicode Wideband CDMA signal is amplitude limited such that the signal amplitude of the non-coherently added carrier signals never exceeds a predefined threshold S_{P}.

In the embodiment depicted in FIG. 4, amplitude limitation is performed based on an estimate of the joint amplitude of the multiple carriers. To this end the sum of the individual carrier amplitudes is estimated using for each individual carrier an element 38 for determining the respective signal magnitude and a summation element 40 for summing the amplitudes of the chip sequences of all carriers. An element 42 determines and outputs the greater of the sum thus obtained and the predefined threshold S_{P}. The output of element 42 is inverted by an inverter 44. By multiplying the output signal of the inverter 44 with the predefined threshold S_{P} in a multiplier 46, a scaling factor is obtained. Finally, the individual chip sequence of each carrier is scaled by this scaling factor to ensure that the joint amplitude of the chip sequences of all carriers never exceeds the predefined threshold S_{P}.

### Successive Peak Cancellation

As has been described in context with FIG. 3, successive peak cancellation (SPC) is performed using two (or, if required, more) individual peak cancellation units arranged in series. In the exemplary embodiment described hereinafter, a peak to be suppressed is cancelled by subtracting a pulse having an appropriate form from the baseband signal prior to pulse shaping. The pulse to be subtracted is chosen such that the subtracted pulse does not widen the signal spectrum and has minimum energy. Taking into account these constraints, an equation can be derived that describes for an individual peak cancellation unit of a single carrier transmit chain as depicted in FIG. 1 an optimum peak cancellation strategy:

$$\tilde{c} [ k ] = c [ k ] - \frac{{h}_{c} ( {t}_{p} - {kT}_{c} )}{{\sum }_{k = 0}^{k max} {h}_{c}^{2} ( {t}_{p} - {kT}_{c} )} \cdot \frac{\vert s ( {t}_{p} ) \vert - {S}_{p}}{\vert s ( {t}_{p} ) \vert} \cdot s ( {t}_{p} ) \qquad ( 1 )$$

where k is the digital time index, T_{C} is the chiptime, c[k] is the input chip sequence of the particular peak cancellation unit, \tilde{c}[k] is the output chip sequence of the particular peak cancellation unit, and tₚ is the time position of a peak maximum that is higher than the threshold Sₚ.

As becomes apparent from equation (1), the output chip sequence \tilde{c}[k] is obtained from the input chip sequence c[k] by subtracting a term that has three components. The first component relates to the normalized shape h_{c} of the pulse that is subtracted to cancel a particular peak (in the following, h_{c} is thus called peak cancellation filter)

The second component denotes the portion of the peak that is above the threshold Sₚ and the third component s(tₚ) is an estimate of the processed signal, here an estimate of the baseband signal subjected to a pulse shaping operation. The estimate s(tₚ) is a convolution of the chip sequence c[k] with the peak estimation filter hₑ which in the present case simulates the effects of the pulse shaping filter, i.e. the RRC filter in the case Wideband CDMA. Thus, s(tₚ) can be written as

$$s ( {t}_{p} ) = {\sum }_{k = 0}^{k max} c [ k ] \cdot {h}_{e} ( {t}_{p} - {kT}_{c} ) \qquad ( 2 )$$

Equations (1) and (2) describe an exemplary peak cancellation strategy for the single carrier transmit chain of FIG. 1. For the multiple carrier transmit chain of FIG. 2, the amplitude peaks appearing in an accumulation of the carrier signals have to be assessed. Let cₘ[k] be the chip sequence of carrier signal m, Sₘ(t) be the estimate for the processed signal and s_{MC}(t) be an estimate for the accumulated multi carrier (MC) signal. Equation (1) can then be written for the multiple carrier scenario as follows:

$$\tilde{c} [ k ] = {c}_{m} [ k ] - \frac{{h}_{c} ( {t}_{p} - {kT}_{c} )}{{\sum }_{k = 0}^{k max} {h}_{c}^{2} ( {t}_{p} - {kT}_{c} )} \cdot \frac{\vert {s}_{MC} ( {t}_{p} ) \vert - {S}_{p}}{\vert {s}_{MC} ( {t}_{p} ) \vert} \cdot {a}_{m} \cdot {s}_{m} ( {t}_{p} ) \qquad ( 3 )$$

where aₘ is a weighting factor for carrier signal m that controls the distribution of peak cancellation over the various carrier signals. Preferably, peak cancellation is distributed equally amounting the various carrier signals, i.e. aₘ=1 for m=1, 2, . . . M.

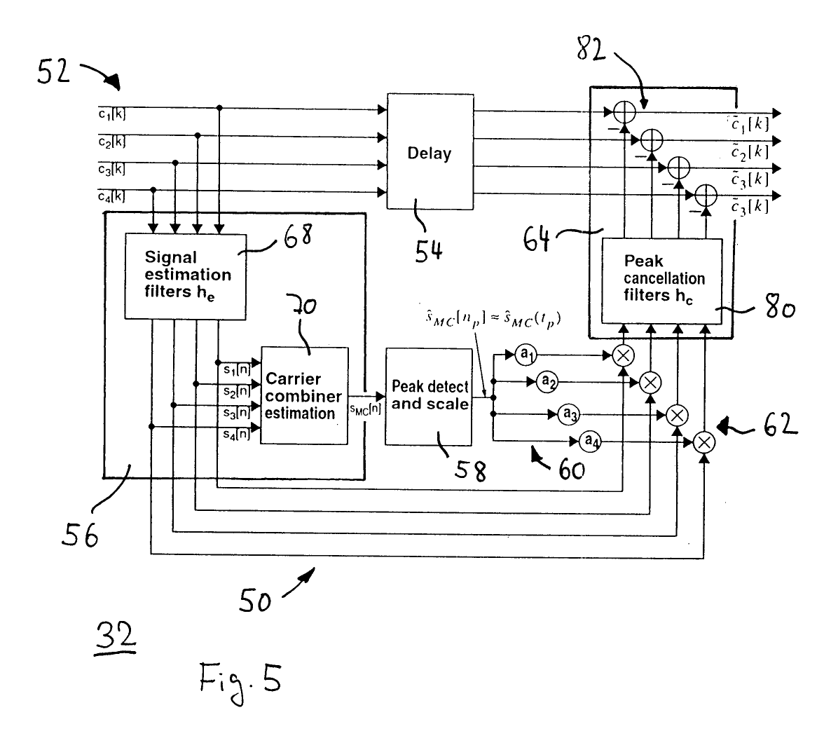

In FIG. 5 the block diagram of a possible hardware implementation of equation (3) for a 4 carrier scenario is depicted. As can be seen from FIG. 5, the peak cancellation unit 32 has a lower branch 50 and an upper branch 52. The lower branch 50 determines the correction signal (i.e. the pulse) that is to be subtracted from the baseband signal. The upper branch 52 delays the baseband signal to compensate for the processing latency in the lower branch 50. To that end a delay unit 54 is arranged in the upper branch 52 for synchronisation purposes.

The lower branch 50 comprises an estimating element 56, a detector 58, a plurality of weighting elements 60, a multiplication block 62 as well as an adjusting element 64.

1. Signal Estimation

Signal estimation is performed in the estimating element 56 which includes several estimating components 68, 70, each estimating component 68, 70 simulating the effects of a particular signal processing operation performed after peak cancellation. In the embodiment depicted in FIG. 5, a first estimating component 68 simulates the effects of pulse shaping and a second estimating component 70 simulates the effects of carrier combination.

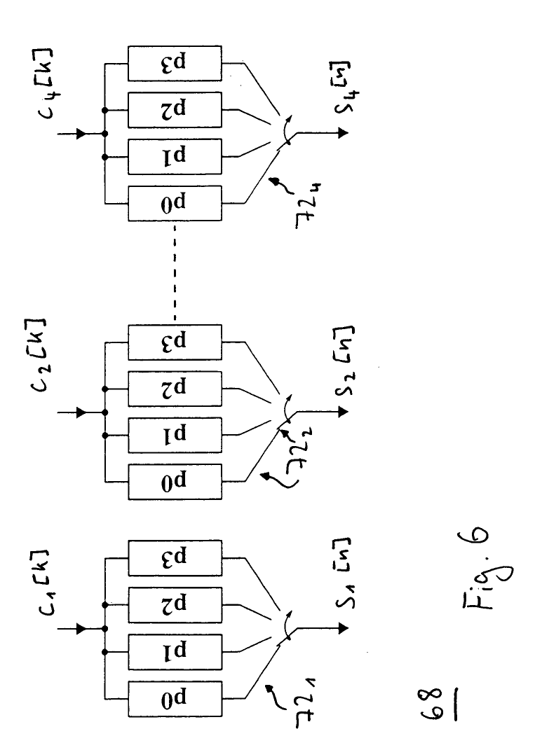

A possible implementation of the first estimating component 68 is depicted in FIG. 6. As becomes apparent from FIG. 6, the first estimating component 68 includes a bank of in this example 4 identical signal estimation filters 72₁, 72₂, etc., one for each carrier signal. The filter bank of the first estimating element 68 simulates the effects of the block 16′ of pulse shaping filters depicted in FIG. 2.

In equation (3) the estimates sₘ(t) output by the first estimating component 68 are signals belonging to the analog domain. In a digital hardware implementation as depicted in FIG. 5, these signals may be sampled with a certain over sampling factor compared to the incoming baseband signal. Thus, the signal estimation filters 72₁ . . . 72₄ can be configured as digital interpolation filters having an impulse response of the desired pulse shaping function. As has been explained above, for Wideband CDMA an RRC shape with roll off factor of 0.22 is selected.

Since in the present embodiment the signal estimation filters 72₁ . . . 72₄ can be implemented as interpolation filters, various different methods known from multi rate filter theory can be applied. In the embodiment depicted in FIG. 6, the individual signal estimation filters are configured as interpolating FIR polyphase filters having an interpolation factor of 4. However, alternative approaches could be used also. For example, a cascade of consecutive polyphase filters that each have low interpolation factors and whose product is the total interpolation factor could be used as well. In general, the latency caused by the individual signal estimation filters (corresponding to half of the impulse response length) is to be considered by the delay element 54 in the upper branch 52 of the peak cancellation unit 32 depicted in FIG. 5.

Returning to the particular filter implementation of FIG. 6, the polyphase p₀ (partial filter) of a particular one of the signal estimation filters 72₁ . . . 72₄ consists of the coefficients eₒ, eₒ₊₄, eₒ₊₈ . . . e_{o+Le-O}. Here, Lₑ denotes the number of filter coefficients, eₗ denotes the filter coefficients (l=0, 1 . . . Lₑ−1), O denotes the interpolation or over sampling factor and o is the index of a particular polyphase (o=0, 1, . . . O−1).

The main parameters that need to be selected for signal estimation filtering are the filter length (filter order) and the over sampling factor (interpolation factor). In the present embodiment the output signals of the first estimating component 68 need not be identical (i.e. need not be of the same accuracy) like the output signals of the block 16′ of pulse shaping filters depicted in FIG. 2. In other words, an estimate of the individual output signals of the block 16′ of pulse shaping filters gives sufficient information about the form and location of amplitude peaks in the pulse shaped signal. Therefore, the signal estimation filters 71₁ . . . 71₄ of the first estimating component 68 can be truncated versions of the individual pulse shaping filters. In the case of a FIR type pulse shaping filter it is usually sufficient to cut out a subset of coefficients around the centre of an amplitude peak. In a Wideband CDMA environment, the length of such a cut out portion should at least extend over 8 intervals.

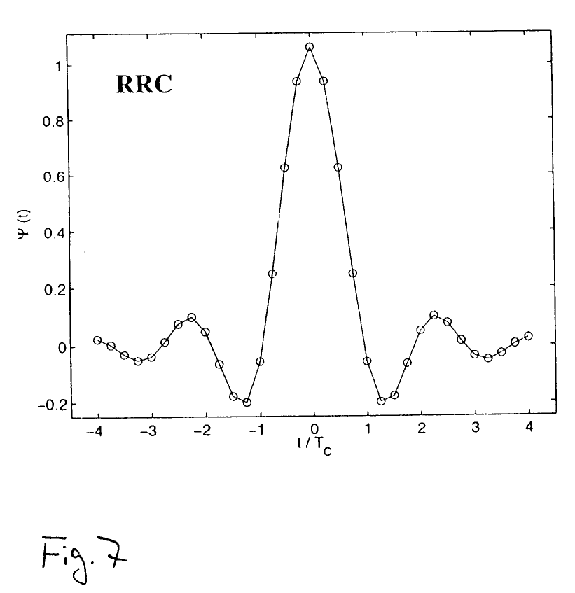

Furthermore, the over sampling factor should amount to at least 4. Considering the preferred solution of a symmetrical impulse response with a centre sample at its maximum, the interpolation filter has a total of at least 4×8+1=33 coefficients or, generally spoken, O×Lₑ+1. Of course, the filter can also have an even number of coefficients when the impulse response maximum is located between two samples or can be asymmetrical. For the preferred solution, the pulse shape of an individual RRC signal estimation filter is plotted in FIG. 7.

So far, the structure and function of the first estimating component 68 of the estimating element 56 has been described. As has been mentioned, the first estimating component 68 simulates the effects of a block of pulse shaping filters on the baseband signal. As becomes apparent from FIG. 2, in a multi carrier scenario the individual baseband signals are not only subjected to the processing operation of pulse shaping, but are additionally subjected to carrier combination (reference numerals 24 and 26 in FIG. 2). Thus, the estimating element 56 of the peak cancellation unit 32 depicted in FIG. 5 additionally comprises a second estimating component 70 for simulating the effects of carrier combination. Obviously, such a second estimating component 70 is only needed in a multi carrier scenario.

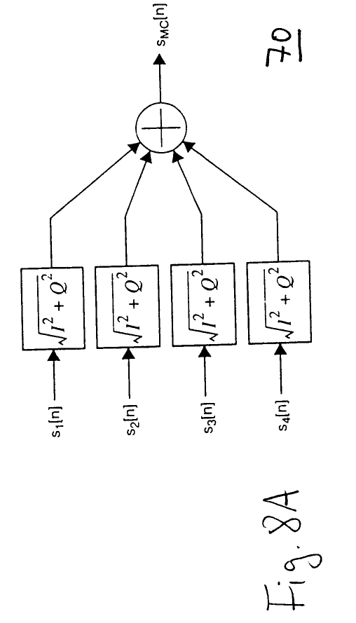

The structure of a first embodiment of the second estimating component 70 is depicted in FIG. 8A. According to the non coherent approach depicted in FIG. 8A, the magnitudes of the individual output signals of the first estimating component 68 are determined and then added. This is a “worst case” estimation which assumes that within a chip time all carriers at one instant add up with the same phase. This, however, is quite likely because the relative phase rotation due to the mutual frequency shift of the carrier signals is more then 2π. This is due to the fact that the mutual frequency shifts of Wideband CDMA signals are multiples of 5 MHz, whereas the chip rate is only 3.84 MHz.

According to an alternative implementation of the second estimating component 70 depicted in FIG. 5, a coherent carrier combination approach can be used taking into account the oscillator signals that are mixed with the transmit signals to shift them in frequency. A possible implementation of such an alternative estimating component 70′ is shown in FIG. 8B.

If the coherent carrier combination approach depicted in FIG. 8B is chosen, a tight control of the initial phase of the oscillator signals is required. This means that for a certain instant in time the phases of the oscillator signals in the second estimating component of each peak cancellation unit must be the same as in the carrier combination structure (reference numerals 24 and 26 in FIG. 2) after pulse shaping when the signal arrives there. This means that the initial phases of the oscillator signals in the second estimation component 70′ of FIG. 8B must be set advanced in accordance with the latency time compared to the initial phases of the actual carrier combination structure after pulse shaping. To that end the second estimating component 70′ depicted in FIG. 8B includes a face control unit 76.

2. Peak Detection

The estimate for the processed signal derived by the estimating element 56 of FIG. 5 from the baseband signal is input to the detector 58 of FIG. 5. The detector 58 assesses the estimate for the pulse shaped and carrier combined signal to detect any amplitude peaks above the predefined threshold Sₚ. Additionally, the detector 58 performs a scaling operation.

The peak detection and the scaling operations performed by the detector 58 correspond to the term
(|s_{MC}(tₚ)|−Sₚ)/|s_{MC}(tₚ)| (4)
in equation (3). The output of the detector 58 is a train of scaled impulses at ŝ_{MC}[nₚ] the time positions tₚ of peak maxima belonging to amplitude peaks higher than the threshold Sₚ.

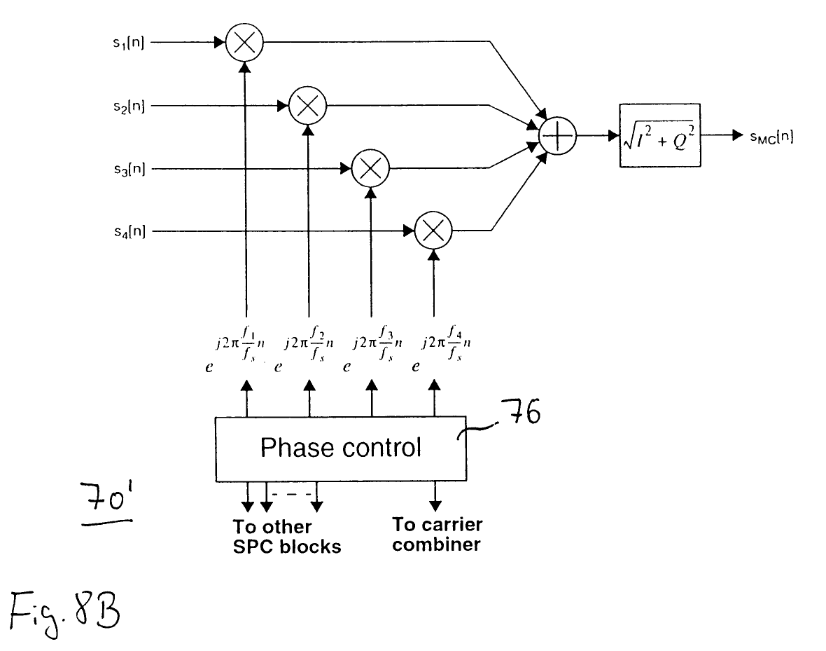

Two different implementations of the detector 58 are depicted in FIGS. 9A and 9B. Since the operations performed in the individual blocks of the detector 58 of FIG. 9A and the detector 58′ of FIG. 9B are self-explaining to a person skilled in the art, a more detailed description thereof is omitted. It should be noted, however, that the negative sign of the output −ŝ_{MC}[nₚ] of the detector 58′ depicted in FIG. 9B can be compensated by removing the minus sign prior to the summation block of the adjusting element 64 depicted in FIG. 5.

According to the detector approaches depicted in FIGS. 9A and 9B, only those samples are recognized as peak maxima that are greater than both the preceding and the following sample. To obtain high recognition accurency, double precision values should be used. If double precision values are employed, comparisons like less-equal or greater-equal should not be used because as a result of such comparisons amplitude peaks might be detected where the assessed estimate is partly constant. However, due to signal quantization effects small differences between adjacent samples can vanish. In such a case actual signal peaks might erroneously not be detected. This might necessitate detector implementations that consider more than three adjacent samples and that include an appropriate combination of less, greater, less-equal and greater-equal comparisons depending on the actual needs.

3. Signal Weighting

The train of scaled impulses ŝ_{MC}[nₚ] output by the detector 58 is split to a number of branches corresponding to the number M=4 of carriers and input to the weighting element 60 depicted in FIG. 5. In the weighting element 60 individual weighting factors aᵢ can be defined for each of the four branches. In the present embodiment equal weights (aᵢ=1, i=1, . . . 4) are used.

Each of the weighted impulse trains output by the weighting element 60 is then multiplied with the corresponding estimate for the pulse shaped signal sₘ[n]. Thus, the individual estimates are scaled according to their contribution to the amplitude peak and their phases are adapted to the phase of the respective baseband signal of the corresponding carrier at the peak maximum.

4. Peak Cancellation

The scaled impulse trains output by the multiplication block 62 are input to the adjusting element 64 of FIG. 5. The adjusting element 64 comprises a first adjusting component 80 for calculating a correction signal and a second adjusting component 82 in the form of a summation block 82.

The first adjusting component 80 calculates for each carrier signal a correction signal in the form of a pulse having an appropriate shape. By means of the summation block 82 the pulses calculated by the first adjusting component 80 are subtracted from the chip sequences that have been delayed by means of the delay element 54. Thus, the individual baseband signals (in the form of the chip sequences) are adjusted such that any detected amplitude peaks do not appear at a later point in time in the pulse shaped and combined baseband signal.

As has been mentioned before, the input signal of the estimating element 56 is over sampled compared to the chip sequence. Thus, the adjusting element 64 has additionally to decimate down to the chip rate.

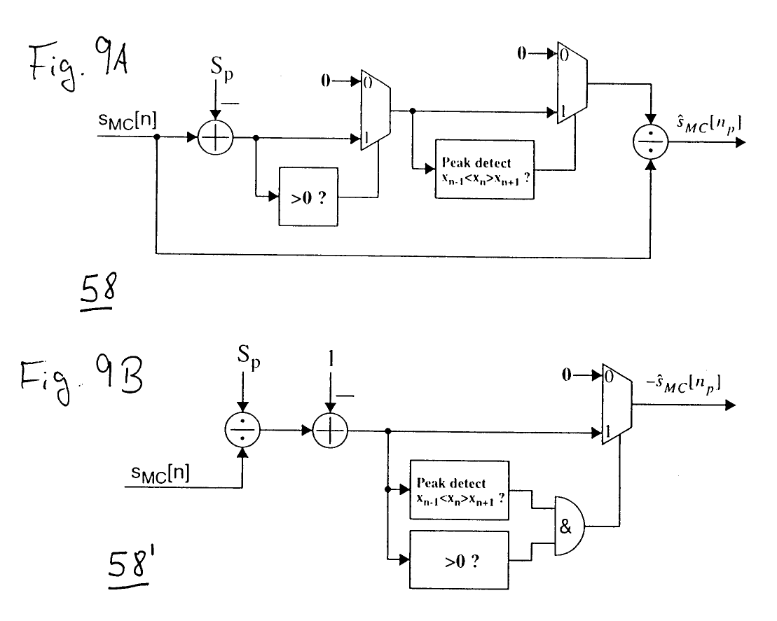

In the present embodiment the first adjusting component 80 of the adjusting element 64 is configured as a peak cancellation filter block including for each of the four branches an individual peak cancellation filter. A possible implementation of the peak cancellation filter block constituting the first adjusting component 80 is depicted in FIG. 10.

From FIG. 10 it can be seen that the first adjusting element 80 includes four individual peak cancellation filters 84₁ . . . 84₄ which each determine an individual correction signal for a particular carrier signal.

As has been mentioned above, the peak cancellation filters 84₁ . . . 84₄ do not only have to calculate appropriate correction signals, but additionally have to decimate down to the chip rate. Since in the present embodiment the peak cancellation filters 84₁ . . . 84₄ also have to fulfill the task of decimation, various methods known from multi rate filter theory can be applied. For example each peak cancellation filter 84₁ . . . 84₄ can be configured as a decimating FIR polyphase filter. In the embodiment depicted in FIG. 10 the decimation factor is 4. If the number of filter coefficients is denoted L_{c}, the filter coefficients are denoted by cₗ, (l=O, 1, . . . L_{c}−1), the decimation or over sampling factor is denoted O (as for the signal estimation filters of the first estimating component 68) and the index of a particular polyphase is denoted by o (o=O, 1, . . . O−1), then the polyphases pₒ, which are partial filters, consist of the coefficients cₒ, cₒ₊₄, cₒ₊₈, . . . C_{o+Lc-O}.

As for the signal estimation filters described in context with the estimating element 56 of FIG. 5, various approaches can be used for decimating filtering. For example cascades of consecutive polyphase filters that each have a low decimation factor and whose product is the total decimation factor could be employed. The latency caused by the polyphase filters, which corresponds to half of the impulse response length, has to be considered by the delay element 54 in the upper branch 52.

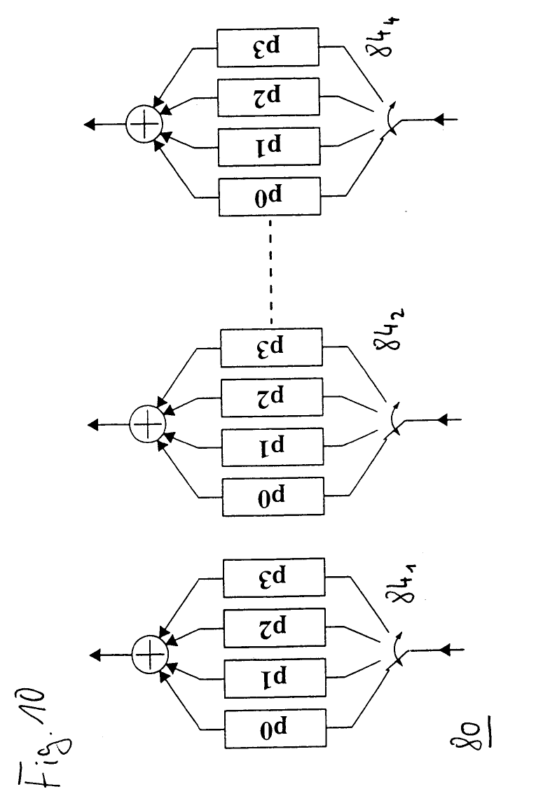

Each polyphase in the peak cancellation filters 84₁ . . . 84₄ generates a subsampled cancellation pulse whose samples are aligned to the instants of the chip samples but whose centre of gravity has a time position that corresponds to the time instant of the peak maximum, which can be anywhere between the chip instants. Thus, the selected polyphase represents one of the O time positions of an over sampled pulse between two chip samples. These time positions are advantageously arranged such that the chip is centered around the O samples of the over sampled signal closest to it. This is illustrated in FIG. 11. The polyphase with index 2 is used when the peak maximum coincides with the chip time. Polyphases O or 1 are used if the peak maximum is found two or one over sampled time intervals before the closest chip time and polyphase 3 if the peak maximum is found one interval after the closest chip time.

The individual peak cancellation filters 84₁ . . . 84₄ could have various filter characteristics. For example, the peak cancellation filters 84₁ . . . 84₄ could have the same filter characteristics like the signal estimation filters included in the estimating element 56. In a Wideband CDMA scenario this could be an RRC characteristics. However, it has been observed that cancellation pulses having an RRC characteristics may cause an RRC like deformation of the spectrum of the suggested baseband signal. This is due to the fact that the spectrum of the cancellation pulses is added (by means of the multiplication block (82 depicted in FIG. 5) to the baseband signal to be adjusted. To avoid a deformation of the adjusted baseband signal, the individual peak cancellation filters 84₁ . . . 84₄ depicted in FIG. 10 could have a flat filtering characteristics. For example, a sin(x)/x function could be used. However, any other filtering characteristics like gaussian could be used also.

It has been found that the filter length (i.e. filter order) may be surprisingly low. In many cases it will be sufficient to have a filter length that extends over only 3 chips. This means that each polyphase consists of three coefficients. With an oversampling factor of for example 4, the decimation filter will thus have a total of 12 coefficients. It is even possible to use only one coefficient per polyphase. In such a case the filtering reduces to simple weighting of the incoming pulses according to their timing relative to the corresponding chip sample.

In FIG. 11 the peak cancellation coefficients for a preferred solution are plotted. The indices at the coefficient points indicate the corresponding polyphase. Polyphase 2 is used if the peak top coincides with the instants of the chip samples.

It has been found that the overall latency caused by a particular peak cancellation unit 32 as depcited in FIG. 5 is rather low. In the embodiment described above with the signal estimation filters extending over 8 chips and peak cancellation filters extending over 3 chips, the latency amounts to 5 chips.

So far the first peak cancellation unit 32 of FIG. 3 has been described. The second (and any further) peak cancellation unit 32′ could have an identical or a similar construction.

Mean Power Loss Compensation

After the baseband signal has been adjusted by the successive peak cancellation units 32, 32′, mean power loss compensation as depicted in FIG. 3 is performed. As can be gathered from FIG. 3, the mean power loss compensator 34 is preferably placed in the signal path after the last peak cancellation unit 32′. However, the mean power loss compensator 34 could also be placed before the baseband clipping unit 30 or somewhere between the baseband clipping unit 30 and the last peak cancellation unit 32′.

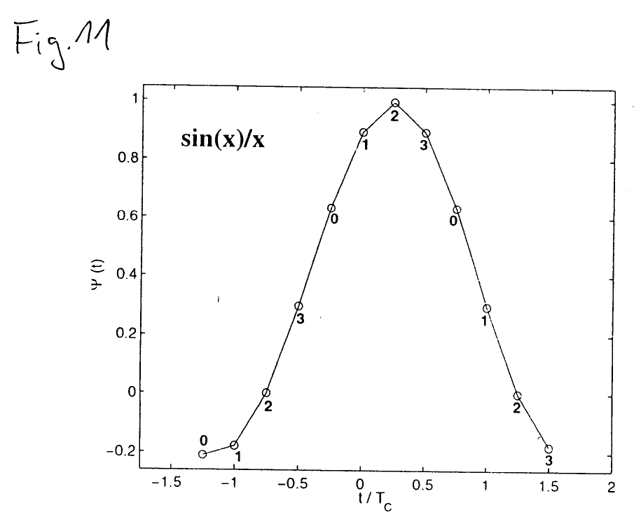

A possible realization of the mean power loss compensator 34 is depicted in FIG. 12. As can be seen from FIG. 12, the mean power loss compensator 34 includes two individual power sensors 88, 90. A first one of the power sensors 88 is located in the loop 36 tapping the signal path prior to the baseband clipping unit 30. A second power sensor 90 is arranged in a branch tapping the signal path after the last peak cancellation unit 32′. The power sensor 88 measures the average power before and the other power sensor 90 after peak power reduction. By forming the quotient of the two measurements a compensation gain in the form of a multiplicative factor is calculated and later on associated with the successively adjusted baseband signal to re-establish the initial power level.

Due to the high dynamic behaviour of the signals measured by the two power sensors 88, 90, special care has to be taken. Parameters like the averaging time and the time until a new sensor value is output must be adapted to the signal characteristics.

The averaging time should not be too short because otherwise the variance of the result would be too high, causing too much variations in the compensation factor. On the other hand the averaging time should not be too long because otherwise larger differences between the actual power level and the intended power level may occur during periods of faster signal power changes. A good compromise is to select the averaging time in the range of the power control periods. It is additionally of benefit if the latency between the measurement period and the actual compensation of the adjusted baseband signal is as short as possible. A good approach to keep this latency short is a moving average strategy. For a Wideband CDMA signal the averaging time can be a frame and a power value may be generated every slot time. Other possibilities are digital low path filters of any kind, IIR and/or FIR, with suitable time constants.

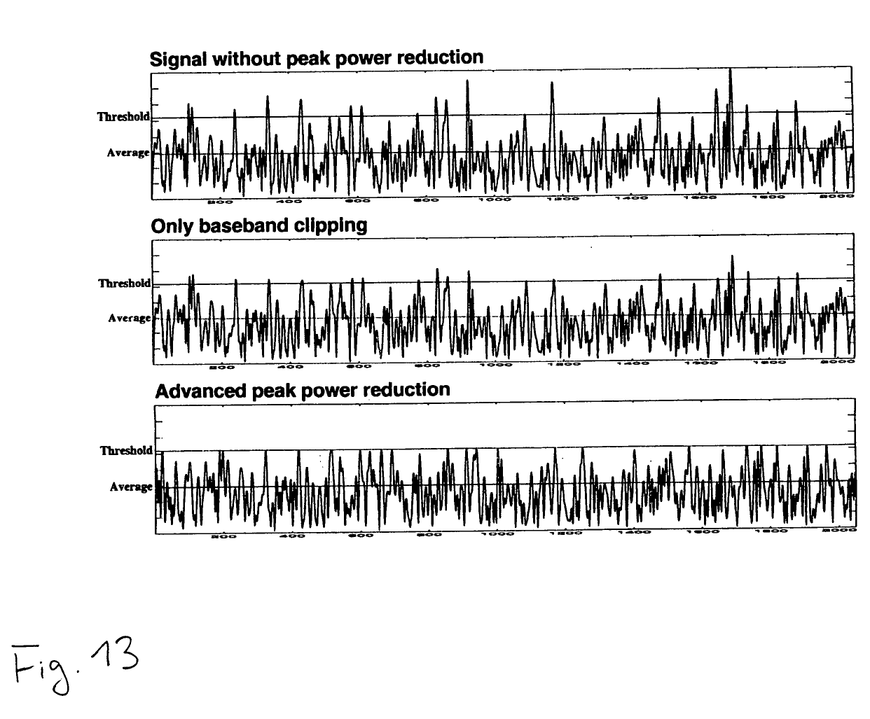

In FIG. 13 the amplitudes of various Wideband CDMA signals are shown. The upper Wideband CDMA signal of FIG. 13 is not subjected to any peak power reduction. Consequently, there are a lot of signal overshoots over a predefined threshold value. The Wideband CDMA signal in the middle of FIG. 13 is subjected to baseband clipping only. It is readily apparent that there are still a lot of signal overshoots over the predefined threshold. In the lower portion of FIG. 13 a Wideband CDMA signal subjected to the advanced power reduction strategy depicted in FIG. 3 is shown. Obviously, signal overshoots over the predefined threshold do no longer appear.

While the present invention has been described with respect to particular embodiments, those skilled in the art will recognize that the present invention is not limited to the specific embodiments described and illustrated herein. Therefore, while the present invention has been described in relation to its preferred embodiments, it is to be understood that this disclosure is only illustrative. Accordingly, it is intended that the invention be limited only by the scope of the claims appended hereto.

1-17. (canceled)

18. A method of preventing amplitude peaks from appearing in a processed signal that has been generated from at least one baseband signal by one or more signal processing operations, comprising:
a) subjecting the baseband signal which is to be processed to a first peak cancellation step including:
deriving from the baseband signal a first estimate for the processed signal, including subjecting the baseband signal to an estimation filtering operation based on a set of filter coefficients;
assessing the first estimate to detect amplitude peaks;
adjusting the baseband signal to prevent any amplitude peaks detected in the first estimate from appearing in the processed signal; and
b) subjecting the adjusted baseband signal which is to be processed to at least one additional peak cancellation step including:
deriving from the adjusted baseband signal a second estimate for the processed signal, including subjecting the baseband signal to an estimation filtering operation based on the set of filter coefficients used in the first peak cancellation step;
assessing the second estimate to detect amplitude peaks;
further adjusting the adjusted baseband signal to prevent any amplitude peaks detected in the second estimate from appearing in the processed signal.

19. The method of claim 18, wherein one or more of the peak cancellation steps are performed in a forward direction only.

20. The method of claim 18, wherein in one or more of the peak cancellation steps the estimate for the processed signal is derived by simulating the effects of the one or more signal processing operations performed to generate the processed signal.

21. The method of claim 20, wherein deriving the estimate for the processed signal includes at least one of signal filtering and signal combination.

22. The method of claim 18, wherein in one or more of the peak cancellation steps the assessment of the estimate for the processed signal includes a threshold decision.

23. The method of claim 22, wherein the assessment involves a routine that produces a train of output signals at the time positions of peak maxima which are higher than a threshold.

24. The method of claim 18, wherein in one or more of the peak cancellation steps the baseband signal to be processed is adjusted using a correction signal derived by way of filtering.

25. The method of claim 24, wherein during a particular peak cancellation step the filtering applied when deriving the estimate for the processed signal differs from the filtering applied when adjusting the signal to be processed.

26. The method of claim 18, further comprising determining and compensating at least a signal power loss that resulted from one or more of the peak cancellation steps.

27. The method of claim 18, further comprising subjecting the signal to be processed to at least one clipping step.

28. The method of claim 18, wherein a plurality of baseband signals in the form of individual carriers are in parallel subjected to a particular one of the peak cancellation steps.

29. The method of claim 28, wherein during the particular peak cancellation step a combined estimate is derived for the plurality of carriers and wherein the assessment is based on the combined estimate.

30. A computer program product comprising program code portions for performing the steps of claim 18 when the computer program product is run on a computing device.

31. The computer program product of claim 30, stored on a computer readable recording medium.

32. A peak cancellation stage for preventing amplitude peaks from appearing in a processed signal that has been generated from at least one baseband signal by one or more signal processing operations, comprising:
a first peak cancellation unit including:
a) an estimating element for deriving from the baseband signal to be processed a first estimate for the processed signal, wherein the estimating element comprises an estimation filter operating based on a set of filter coefficients;
b) a detector for assessing the first estimate to detect amplitude peaks;
c) an adjusting element for adjusting the baseband signal to prevent any amplitude peaks detected in the first estimate from appearing in the processed signal;
at least one additional peak cancellation unit arranged in a signal path behind the first peak cancellation unit and including:
a) an estimating element for deriving from the adjusted baseband signal a second estimate for the processed signal, wherein the estimating element comprises an estimation filter operating based on the same set of filter coefficients like the first peak cancellation unit;
b) a detector for assessing the second estimate to detect amplitude peaks;
c) an adjusting element for further adjusting the adjusted baseband signal to prevent any amplitude peaks detected in the second estimate from appearing in the processed signal.

33. The peak cancellation stage of claim 32, wherein one or more of the peak cancellation units have a first signal branch including at least the estimating element and the detector and a second signal branch arranged in parallel to the first signal branch and including a delay element.

34. A transmitting device comprising the peak cancellation stage according to claim 32.
